(19) United States
(12) Patent Application Publication
(10) Pub. No.: US 2022/0183376 A1
(43) Pub. Date: Jun. 16, 2022

(54) AEROSOL PROVISION DEVICE

(71) Applicant: Nicoventures Trading Limited, London (GB)

(72) Inventors: Thomas Paul BLANDINO, Cottage Grove, WI (US); Mitchel THORSEN, London (GB)

(21) Appl. No.: 17/593,155

(22) PCT Filed: Mar. 9, 2020
(86) PCT No.: PCT/EP2020/056236

§ 371 Date: Sep. 10, 2021

Related U.S. Application Data
(60) Provisional application No. 62/816,251, filed on Mar. 11, 2019.
(60) Provisional application No. 62/816,306, filed on Mar. 11, 2019.

(51) Int. Cl. A24F 40/465; H05B 6/44; H05B 6/10

(52) U.S. Cl. CPC A24F 40/465; H05B 6/105; H05B 6/44

(57) ABSTRACT

An aerosol provision device comprises an inductor coil configured to generate the varying magnetic field for heating the susceptor arrangement. The inductor coil is helical, formed from litz wire and comprises between about 25 and about 350 wire strands.

### PRIORITY CLAIM

The present application is a National Phase entry of PCT Application No. PCT/EP2020/056236, filed Mar. 9, 2020, which claims priority from U.S. Provisional Application No. 62/816,251, filed Mar. 11, 2019, and which claims priority from U.S. Provisional Application No. 62/816,306, filed Mar. 11, 2019, each of which is hereby fully incorporated herein by reference.

### TECHNICAL FIELD

The present invention relates to an aerosol provision device.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure, there is provided an aerosol provision device. The device includes an inductor coil configured to generate a varying magnetic field for heating a susceptor arrangement, wherein the inductor coil is helical and formed from litz wire having an elliptical cross section and comprising between about 25 and about 350 wire strands.

According to another aspect of the present disclosure, there is provided an aerosol provision device. The device includes a susceptor arrangement that is heatable by penetration with a varying magnetic field to heat aerosol generating material; and an inductor coil configured to generate the varying magnetic field for heating the susceptor arrangement, wherein the inductor coil is helical and formed from litz wire having an elliptical cross section and comprising between about 25 and about 350 wire strands.

According to a further aspect of the present disclosure, there is provided an aerosol provision device. The device includes an inductor coil configured to generate the varying magnetic field for heating the susceptor arrangement, wherein the inductor coil is helical and formed from litz wire having a rectangular cross section and comprising between about 25 and about 350 wire strands.

According to another aspect of the present disclosure, there is provided an aerosol provision device. The device includes a susceptor arrangement that is heatable by penetration with a varying magnetic field to heat aerosol generating material; and an inductor coil configured to generate the varying magnetic field for heating the susceptor arrangement, wherein the inductor coil is helical and formed from litz wire having a rectangular cross section and comprising between about 25 and about 350 wire strands.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a front view of an example of an aerosol provision device;

FIG. 2 shows a front view of the aerosol provision device of FIG. 1 with an outer cover removed;

FIG. 3 shows a cross-sectional view of the aerosol provision device of FIG. 1;

FIG. 4 shows an exploded view of the aerosol provision device of FIG. 2;

FIG. 5A shows a cross-sectional view of a heating assembly within an aerosol provision device;

FIG. 5B shows a close-up view of a portion of the heating assembly of FIG. 5A;

FIG. 6 shows first and second inductor coils wrapped around an insulating member;

FIG. 7 shows a first inductor coil;

FIG. 8 shows a second inductor coil;

FIG. 9 shows a diagrammatic representation of cross section of a litz wire;

FIG. 10 shows a diagrammatic representation of a top down view of an inductor coil;

FIG. 11 shows a diagrammatic representation of a cross section of first and second inductor coils, a susceptor and an insulating member;

FIG. 12 shows first and second inductor coils wrapped around an insulating member according to another example;

FIG. 13 shows a first inductor coil according to another example;

FIG. 14 shows a second inductor coil according to another example;

FIG. 15 shows a diagrammatic representation of cross section of a litz wire according to another example;

FIG. 16 shows a diagrammatic representation of a top down view of an inductor coil according to another example; and

FIG. 17 shows a diagrammatic representation of a cross section of first and second inductor coils, a susceptor and an insulating member according to another example.

### DETAILED DESCRIPTION OF THE DRAWINGS

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatuses are known that heat aerosol generating material to volatilize at least one component of the aerosol generating material, typically to form an aerosol which can be inhaled, without burning or combusting the aerosol generating material. Such apparatuses are sometimes described as an “aerosol generating device,” an “aerosol provision device,” a “heat-not-burn device,” a “tobacco heating product device,” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

A first aspect of the present disclosure defines at least one inductor coil which is configured to generate a varying magnetic field for penetrating and heating a susceptor. As will be discussed in more detail herein, a susceptor (also known as a susceptor arrangement) is an electrically conducting object, which is heatable by the varying magnetic fields. An article comprising aerosol generating material can be received within the susceptor, or be arranged near to, or in contact with the susceptor. Once heated, the susceptor transfers heat to the aerosol generating material, which releases aerosol. In one example, the susceptor defines a receptacle and the susceptor receives the aerosol generating material.

In the first aspect, the inductor coil is helical and is formed from litz wire having an elliptical cross section which comprises a plurality of wire strands. A litz wire is a wire comprising a plurality of wire strands which is used to carry alternating current. Litz wire is used to reduce skin effect losses in a conductor, and comprises a plurality of individually insulated wires which are twisted or woven together. The result of this winding is to equalize the proportion of the overall length over which each strand is at the outside of the conductor. This has the effect of distributing the current equally among the wire strands, reducing the resistance in the wire. In some examples the litz wire comprises several bundles of wire strands, where the wire strands in each bundle are twisted together. The bundles of wires are then twisted or woven together in a similar way.

In the present disclosure, the litz wire of the inductor coil has between about 25 and about 350 wire strands. It has been found that an inductor coil formed with litz wire having an elliptical cross section and this many wire strands is suitable for heating a susceptor used in an aerosol provision device. It also provides a good balance between performance and cost.

Preferably, the litz wire of the inductor coil has between about 60 and about 150 wire strands. The litz wire may comprise between about 100 and about 130 wire strands, or between about 110 and about 120 wire strands.

In one example, the litz wire of the inductor coil has about 115 wire strands. Such a litz wire is particularly effective for heating a susceptor used in an aerosol provision device.

In another example, the litz wire of the inductor coil has between about 50 and about 100 wire strands, such as between about 60 and about 90 wire strands, or between about 70 and about 80 wire strands. In one example, the litz wire of the inductor coil has about 75 wire strands.

The litz wire may comprise at least four bundles of wire strands. Preferably, the litz wire comprises five bundles. As briefly mentioned above, each bundle comprises a plurality of wire strands and the wire strands in each bundle are twisted together. The bundles of wires can be twisted/woven together in a similar way. The wire strands in all of the bundles add up to the total number of wire strands in the litz wire. There may be the same number of wire strands in each bundle. When the wire strands are bundled together in the litz wire, and then further woven and twisted in bundles, the proportion of time that each wire spends at the edge of the bundle may be even more.

Each of the wire strands within the litz wire has a diameter. For example, the wire strands may have a diameter of between about 0.05 mm and about 0.2 mm. In some examples, the diameter is between 34 AWG (0.16 mm) and 40 AWG (0.0799 mm), where AWG is the American Wire Gauge. In another example, the wire strands have a diameter of between 36 AWG (0.127 mm) and 39 AWG (0.0897 mm). In another example, the wire strands have a diameter of between 37 AWG (0.113 mm) and 38 AWG (0.101 mm).

Preferably, the wire strands have a diameter of 38 AWG (0.101 mm), such as about 0.1 mm. It has been found that a litz wire with the above specified number of wire strands and these dimensions provide a good balance between effective heating, lower cost, low resistance and ensuring that the aerosol provision device is compact and lightweight.

The litz wire may have a length of between about 300 mm and about 450 mm. For example, the litz wire may have a length between about 300 mm and about 350 mm, such as between about 310 mm and about 320 mm. Alternatively the litz wire may have a length of between about 350 mm and about 450 mm, such as between about 390 mm and about 410 mm. The length of the litz wire is the length when the coil is unraveled. In a particular arrangement, the litz wire has a length of about 315 mm, or about 400 mm. It has been found that these lengths are suitable for providing effective heating of the susceptor.

The inductor coil may have a length of between about 15 mm and about 35 mm. The length is measured along the axis of the helix formed by the coil. For example, the length may be between about 15 mm and about 25 mm, or between about 25 mm and about 35 mm. Preferably the inductor coil has a length of about 20 mm or about 27 mm.

The inductor coil may have between about 5 and 9 turns. A turn is one complete rotation about an axis. For example, the inductor coil may have between about 6 and 7 turns, such as 6.75 turns, or between about 8 and 9 turns, such as 8.75 turns. Inductor coils with these many turns can provide an effective magnetic field for heating the susceptor.

The inductor coil may comprise a litz wire wound (helically) with a particular pitch. The pitch is the length of the inductor coil (measured along the longitudinal axis of the device/susceptor) over one complete winding. A shorter pitch can induce a stronger magnetic field. Conversely, a longer pitch can induce a weaker magnetic field.

In one arrangement, the pitch is between about 2 mm and about 4 mm, or between about 2 mm and about 3 mm. For example, the pitch may be between about 2.5 mm and about 3 mm. Preferably the pitch is about 2.8 mm or about 2.9 mm, such as about 2.81 mm or about 2.88 mm. It has been found that these particular pitches provide effective heating of the susceptor and hence the aerosol generating material.

A battery can power the inductor coils. The battery may have a voltage of between about 2.9V and 4.16V, and can supply a peak current of about 18 Amps.

In one example, the inner diameter of the inductor coil is about 10-14 mm, and the outer diameter is about 12-16 mm. In a particular example, the inner diameter of the inductor coil is about 12-13 mm, and the outer diameter is about 14-15 mm. Preferably the inner diameter of the coil is about 12 mm, and the outer diameter is about 14.6 mm. The inner diameter of a helical inductor coil is any straight-line segment that passes through the center of the inductor coil (as viewed in cross section) and whose endpoints lie on the inner perimeter of the coil. The outer diameter of a helical inductor coil is any straight-line segment that passes through the center of the inductor coil (as viewed in cross section) and whose endpoints lie on the outer perimeter of the coil. These dimensions can provide effective heating of the susceptor arrangement while retaining a compact outer size.

The inductor coil may comprise gaps between successive turns and each gap may have a length of between about 1.4 mm and 1.6 mm, such as between about 1.5 mm and about 1.6 mm. Preferably the gap is about 1.5 mm or 1.6 mm, such as about 1.51 mm or 1.58 mm. These dimensions provide a magnetic field of a suitable strength for heating the susceptor. The gap length is measured in a direction parallel to the longitudinal axis of the device/susceptor/inductor coil. A gap is a portion where no wire of the coil is present (i.e. there is a space between successive turns).

The inductor coil may have a mass between about 1 g and about 2.5 g. In a particular arrangement, the inductor coil has a mass of between about 1.3 g and 1.6 g, such as 1.4 g or between about 2 g and about 2.2 g, such as 2.1 g.

As mentioned, the litz wire has an elliptical cross section. In a particular example, the litz wire has a circular cross section. The litz wire may therefore have a diameter of between about 1 mm and about 1.5 mm or between about 1.2 mm and about 1.4 mm. Preferably the litz wire has a diameter of about 1.3 mm.

In examples where the litz wire does not have a circular cross section, the major axis of the ellipse may be parallel to a longitudinal axis of the susceptor/coil. The major axis may have a length of between about 1 mm and about 1.5 mm. The minor axis has a length that is shorter than the length of the major axis. The minor axis may have a length of between about 1 mm and about 1.5 mm.

In some examples, in use, the inductor coil is configured to heat the susceptor to a temperature of between about 240 degrees Celsius and about 300 degrees Celsius, such as between about 250 degrees Celsius and about 280 degrees Celsius.

The inductor coil may be positioned away from an outer surface of the susceptor by a distance of between about 3 mm and about 4 mm. Accordingly, an inner surface of the inductor coil and the outer surface of the susceptor may be spaced apart by this distance. The distance may be a radial distance. It has been found that distances within this range represent a good balance between the susceptor being radially close to the inductor coil to allow efficient heating and being radially distant for improved insulation of the induction coil and insulating member.

In another example, the inductor coil may be positioned away from the outer surface of the susceptor by a distance of greater than about 2.5 mm.

In another example, the inductor coil may be positioned away from an outer surface of the susceptor by a distance of between about 3 mm and about 3.5 mm. In a further example, the inductor coil may be positioned away from an outer surface of the susceptor by a distance of between about 3 mm and about 3.25 mm, for example preferably by about 3.25 mm. In another example, the inductor coil may be positioned away from an outer surface of the susceptor by a distance greater than about 3.2 mm. In a further example the inductor coil may be positioned away from an outer surface of the susceptor by a distance of less than about 3.5 mm, or by less than about 3.3 mm. It has been found that these distances provide a balance between the susceptor being radially close to the inductor coil to allow efficient heating and being radially distant for improved insulation of the induction coil and insulating member.

In some examples, each of the plurality of wire strands comprises a bondable coating. A bondable coating is a coating which surrounds each wire strand, and which can be activated (such as via heating), so that the strands within the litz wire bond to one more neighboring strands. The bondable coating allows the litz wire to be formed into the shape of an inductor coil on a support member, and after the bondable coating is activated, the inductor coil will retain its shape. The bondable coating therefore “sets” the shape of the inductor coil. In some examples, the bondable coating is the electrically insulating layer which surrounds the conductive core. However, the bondable coating and the insulation may also be separate layers, and the bondable coating surrounds the insulating layer. In an example, the conductive core of the litz wire comprises copper.

In a particular example, the aerosol provision device comprises the susceptor arrangement. In other examples, an article comprising aerosol generating material comprises the susceptor arrangement.

The susceptor arrangement may be hollow and/or substantially tubular to allow the aerosol generating material to be received within the susceptor, such that the susceptor surrounds the aerosol generating material.

Preferably, the device is a tobacco heating device, also known as a heat-not-burn device.

In a further aspect, the inductor coil is helical and is formed from litz wire having a rectangular cross section which comprises a plurality of wire strands. In this aspect, the litz wire of the inductor coil has between about 25 and about 350 wire strands. Again, it has been found that an inductor coil formed with litz wire having a rectangular cross section and this many wire strands is suitable for heating a susceptor used in an aerosol provision device. It also provides a good balance between performance and cost.

Preferably, the litz wire of the inductor coil has between about 60 and about 150 wire strands. Still more preferably, the litz wire comprises between about 100 and about 130 wire strands, or between about 110 and about 120 wire strands. Most preferably, the litz wire of the inductor coil has about 115 wire strands. Such a litz wire is particularly effective for heating a susceptor used in an aerosol provision device. The litz wire may comprise at least four bundles of wire strands.

The litz wire may comprise at least four bundles of wire strands. Preferably, the litz wire comprises five bundles. There may be the same number of wire strands in each bundle.

Each of the wire strands within the litz wire has a diameter. For example, the wire strands may have a diameter of between about 0.05 mm and about 0.2 mm. In some examples, the diameter is between 34 AWG (0.16 mm) and 40 AWG (0.0799 mm), where AWG is the American Wire Gauge. In another example, the wire strands have a diameter of between 36 AWG (0.127 mm) and 39 AWG (0.0897 mm). In another example, the wire strands have a diameter of between 37 AWG (0.113 mm) and 38 AWG (0.101 mm).

Preferably, the wire strands have a diameter of 38 AWG (0.101 mm), such as about 0.1 mm. It has been found that a litz wire with the above specified number of wire strands and these dimensions provide a good balance between effective heating, lower cost, low resistance and ensuring that the aerosol provision device is compact and lightweight.

The litz wire may have a length of between about 250 mm and about 450 mm. For example, the litz wire may have a length between about 250 mm and about 300 mm, such as between about 280 mm and about 290 mm. Alternatively the litz wire may have a length of between about 400 mm and about 450 mm, such as between about 410 mm and about 420 mm. The length of the litz wire is the length when the coil is unraveled. In a particular arrangement, the litz wire has a length of about 285 mm, or about 420 mm. It has been found that these lengths are suitable for providing effective heating of the susceptor.

The inductor coil may have a length of between about 15 mm and about 35 mm. The length is measured along the axis of the helix formed by the coil. For example, the length may be between about 15 mm and about 25 mm, or between about 25 mm and about 35 mm. Preferably the inductor coil has a length of about 20 mm or about 30 mm.

The inductor coil may have between about 5 and 9 turns. A turn is one complete rotation about an axis. For example, the inductor coil may have between about 5 and 6 turns, such as 5.75 turns, or between about 8 and 9 turns, such as 8.75 turns. Inductor coils with these many turns provide an effective magnetic field for heating the susceptor.

In one arrangement, the pitch is between about 2 mm and about 4 mm, or between about 2.5 mm and about 3.5 mm. For example, the pitch may be between about 3 mm and about 3.5 mm. Preferably the pitch is about 3.1 mm or about 3.2 mm. It has been found that these particular pitches provide effective heating of the susceptor and hence the aerosol generating material.

In one example, the inner diameter of the inductor coil is about 10-14 mm, and the outer diameter is about 12-16 mm. In a particular example, the inner diameter of the inductor coil is about 12-13 mm, and the outer diameter is about 14-15 mm. Preferably the inner diameter of the coil is about 12 mm, and the outer diameter is about 14.3 mm. These dimensions can provide effective heating of the susceptor arrangement while retaining a compact outer size.

The inductor coil may comprise gaps between successive turns and each gap may have a length of between about 0.9 mm and 1 mm. These dimensions provide a magnetic field of a suitable strength for heating the susceptor.

The inductor coil may have a mass between about 2 g and about 4 g. In a particular arrangement, the inductor coil has a mass of between about 2.2 g and 2.6 g, such as 2.4 g or between about 3.3 g and about 3.6 g, such as 3.5 g.

As mentioned, the litz wire in this example has a rectangular cross section. The rectangle may have two short sides and two long sides, where the dimensions of the sides of the rectangle define the area of the rectangular cross section. Other examples may have a generally square cross section, with four substantially equal sides. The cross-sectional area may be between about 1.5 mm² and about 3 mm². In a preferred example, the cross-sectional area is between about 2 mm² and about 3 mm², or between about 2.2 mm² and about 2.6 mm². Preferably the cross-sectional area is between about 2.4 mm² and about 2.5 mm².

In examples having a rectangular cross section with two short and two long sides, the short sides may have a dimension of between about 0.9 mm and about 1.4 mm, and the long sides may have a dimension of between about 1.9 mm and about 2.4 mm. Alternatively, the short sides may have a dimension of between about 1 mm and about 1.2 mm, and the long sides may have a dimension of between about 2.1 mm and about 2.3 mm. Preferably the short sides have a dimension of about 1.1 mm (±0.1 mm) and the long sides have a dimension of about 2.2 mm (±0.1 mm). In such an example, the cross-sectional area is about 2.42 mm².

In a particular example, the aerosol provision device comprises the susceptor arrangement. In other examples, an article comprising aerosol generating material comprises the susceptor arrangement.

Other features of the aerosol provision device and/or wire strands may be the same as in the first aspect.

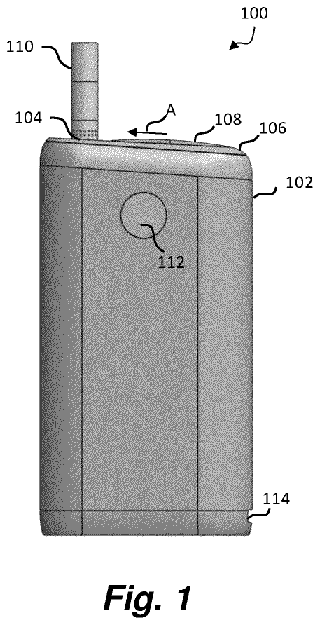

FIG. 1 shows an example of an aerosol provision device 100 for generating aerosol from an aerosol generating medium/material. In broad outline, the device 100 may be used to heat a replaceable article 110 comprising the aerosol generating medium, to generate an aerosol or other inhalable medium which is inhaled by a user of the device 100.

The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly.

The device 100 of this example comprises a first end member 106 which comprises a lid 108 which is moveable relative to the first end member 106 to close the opening 104 when no article 110 is in place. In FIG. 1, the lid 108 is shown in an open configuration, however the cap 108 may move into a closed configuration. For example, a user may cause the lid 108 to slide in the direction of arrow “A”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port.

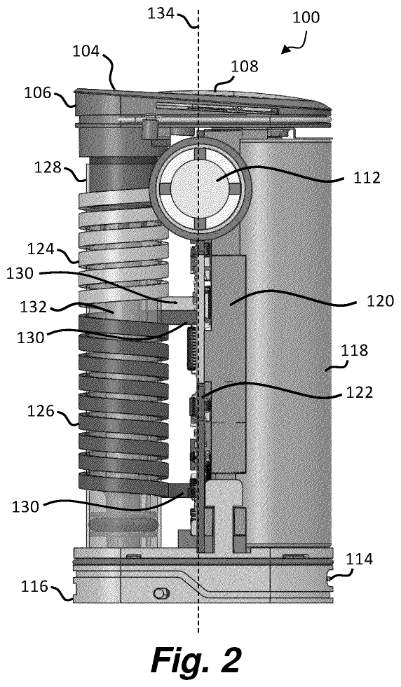

FIG. 2 depicts the device 100 of FIG. 1 with the outer cover 102 removed and without an article 110 present. The device 100 defines a longitudinal axis 134.

As shown in FIG. 2, the first end member 106 is arranged at one end of the device 100 and a second end member 116 is arranged at an opposite end of the device 100. The first and second end members 106, 116 together at least partially define end surfaces of the device 100. For example, the bottom surface of the second end member 116 at least partially defines a bottom surface of the device 100. Edges of the outer cover 102 may also define a portion of the end surfaces. In this example, the lid 108 also defines a portion of a top surface of the device 100.

The end of the device closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows away from the distal end of the device 100.

The device 100 further comprises a power source 118. The power source 118 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the heating assembly to supply electrical power when required and under control of a controller (not shown) to heat the aerosol generating material. In this example, the battery is connected to a central support 120 which holds the battery 118 in place.

The device further comprises at least one electronics module 122. The electronics module 122 may comprise, for example, a printed circuit board (PCB). The PCB 122 may support at least one controller, such as a processor, and memory. The PCB 122 may also comprise one or more electrical tracks to electrically connect together various electronic components of the device 100. For example, the battery terminals may be electrically connected to the PCB 122 so that power can be distributed throughout the device 100. The socket 114 may also be electrically coupled to the battery via the electrical tracks.

In the example device 100, the heating assembly is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e., by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The induction heating assembly of the example device 100 comprises a susceptor arrangement 132 (herein referred to as “a susceptor”), a first inductor coil 124 and a second inductor coil 126. The first and second inductor coils 124, 126 are made from an electrically conducting material. In this example, the first and second inductor coils 124, 126 are made from Litz wire/cable which is wound in a helical fashion to provide helical inductor coils 124, 126. Litz wire comprises a plurality of individual wires which are individually insulated and are twisted together to form a single wire. Litz wires are designed to reduce the skin effect losses in a conductor. In the example device 100, the first and second inductor coils 124, 126 are made from copper Litz wire which has a rectangular cross section. In other examples the Litz wire can have other shape cross sections, such as elliptical.

The first inductor coil 124 is configured to generate a first varying magnetic field for heating a first section of the susceptor 132 and the second inductor coil 126 is configured to generate a second varying magnetic field for heating a second section of the susceptor 132. In this example, the first inductor coil 124 is adjacent to the second inductor coil 126 in a direction along the longitudinal axis 134 of the device 100 (that is, the first and second inductor coils 124, 126 to not overlap). The susceptor arrangement 132 may comprise a single susceptor, or two or more separate susceptors. Ends 130 of the first and second inductor coils 124, 126 can be connected to the PCB 122.

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIG. 2, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in opposite directions. This can be useful when the inductor coils are active at different times. For example, initially, the first inductor coil 124 may be operating to heat a first section/portion of the article 110, and at a later time, the second inductor coil 126 may be operating to heat a second section/portion of the article 110. Winding the coils in opposite directions helps reduce the current induced in the inactive coil when used in conjunction with a particular type of control circuit. In FIG. 2, the first inductor coil 124 is a right-hand helix and the second inductor coil 126 is a left-hand helix. However, in another embodiment, the inductor coils 124, 126 may be wound in the same direction, or the first inductor coil 124 may be a left-hand helix and the second inductor coil 126 may be a right-hand helix.

The susceptor 132 of this example is hollow and therefore defines a receptacle within which aerosol generating material is received. For example, the article 110 can be inserted into the susceptor 132. In this example the susceptor 132 is tubular, with a circular cross section.

The device 100 of FIG. 2 further comprises an insulating member 128 which may be generally tubular and at least partially surround the susceptor 132. The insulating member 128 may be constructed from any insulating material, such as plastic for example. In this particular example, the insulating member is constructed from polyether ether ketone (PEEK). The insulating member 128 may help insulate the various components of the device 100 from the heat generated in the susceptor 132.

The insulating member 128 can also fully or partially support the first and second inductor coils 124, 126. For example, as shown in FIG. 2, the first and second inductor coils 124, 126 are positioned around the insulating member 128 and are in contact with a radially outward surface of the insulating member 128. In some examples the insulating member 128 does not abut the first and second inductor coils 124, 126. For example, a small gap may be present between the outer surface of the insulating member 128 and the inner surface of the first and second inductor coils 124, 126.

In a specific example, the susceptor 132, the insulating member 128, and the first and second inductor coils 124, 126 are coaxial around a central longitudinal axis of the susceptor 132.

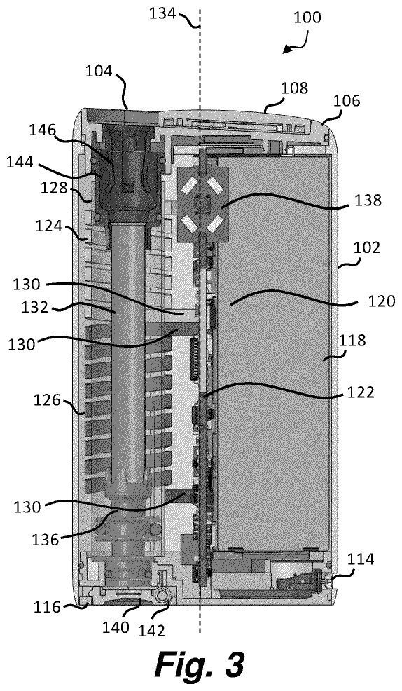

FIG. 3 shows a side view of device 100 in partial cross-section. The outer cover 102 is present in this example. The rectangular cross-sectional shape of the first and second inductor coils 124, 126 is more clearly visible.

The device 100 further comprises a support 136 which engages one end of the susceptor 132 to hold the susceptor 132 in place. The support 136 is connected to the second end member 116.

The device may also comprise a second printed circuit board 138 associated within the control element 112.

The device 100 further comprises a second lid/cap 140 and a spring 142, arranged towards the distal end of the device 100. The spring 142 allows the second lid 140 to be opened, to provide access to the susceptor 132. A user may open the second lid 140 to clean the susceptor 132 and/or the support 136.

The device 100 further comprises an expansion chamber 144 which extends away from a proximal end of the susceptor 132 towards the opening 104 of the device. Located at least partially within the expansion chamber 144 is a retention clip 146 to abut and hold the article 110 when received within the device 100. The expansion chamber 144 is connected to the end member 106.

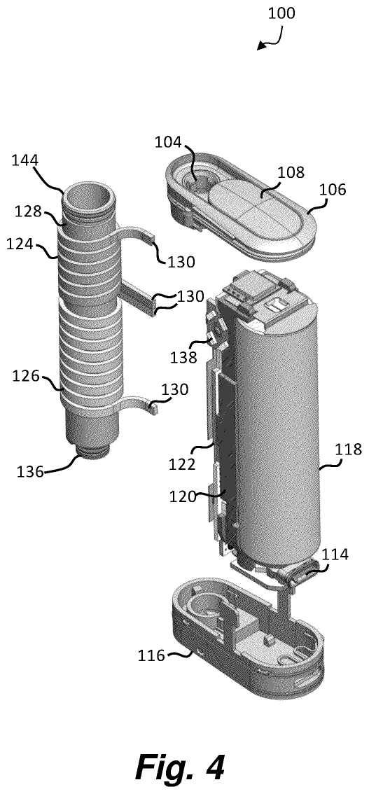

FIG. 4 is an exploded view of the device 100 of FIG. 1, with the outer cover 102 omitted.

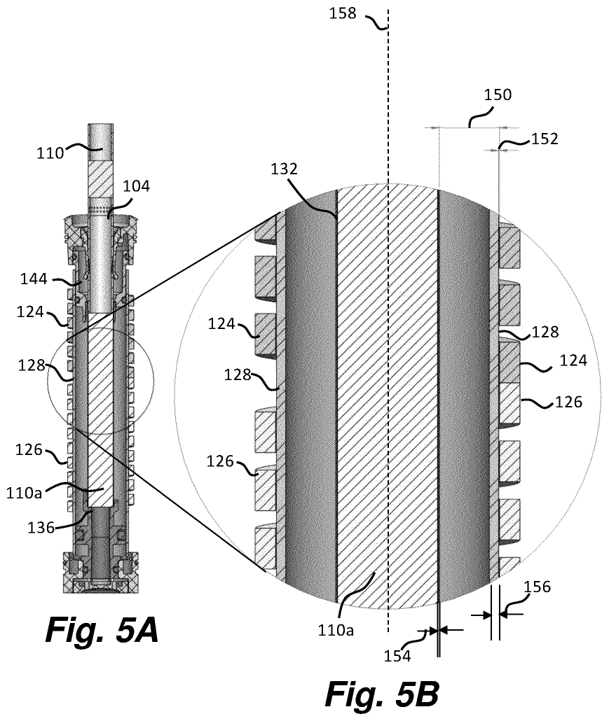

FIG. 5A depicts a cross section of a portion of the device 100 of FIG. 1. FIG. 5B depicts a close-up of a region of FIG. 5A. FIGS. 5A and 5B show the article 110 received within the susceptor 132, where the article 110 is dimensioned so that the outer surface of the article 110 abuts the inner surface of the susceptor 132. This ensures that the heating is most efficient. The article 110 of this example comprises aerosol generating material 110a. The aerosol generating material 110a is positioned within the susceptor 132. The article 110 may also comprise other components such as a filter, wrapping materials and/or a cooling structure.

FIG. 5B shows that the outer surface of the susceptor 132 is spaced apart from the inner surface of the inductor coils 124, 126 by a distance 150, measured in a direction perpendicular to a longitudinal axis 158 of the susceptor 132. In one particular example, the distance 150 is about 3 mm to 4 mm, about 3-3.5 mm, or about 3.25 mm.

FIG. 5B further shows that the outer surface of the insulating member 128 is spaced apart from the inner surface of the inductor coils 124, 126 by a distance 152, measured in a direction perpendicular to a longitudinal axis 158 of the susceptor 132. In one particular example, the distance 152 is about 0.05 mm. In another example, the distance 152 is substantially 0 mm, such that the inductor coils 124, 126 abut and touch the insulating member 128.

In one example, the susceptor 132 has a wall thickness 154 of about 0.025 mm to 1 mm, or about 0.05 mm.

In one example, the susceptor 132 has a length of about 40 mm to 60 mm, about 40-45 mm, or about 44.5 mm.

In one example, the insulating member 128 has a wall thickness 156 of about 0.25 mm to 2 mm, 0.25 to 1 mm, or about 0.5 mm.

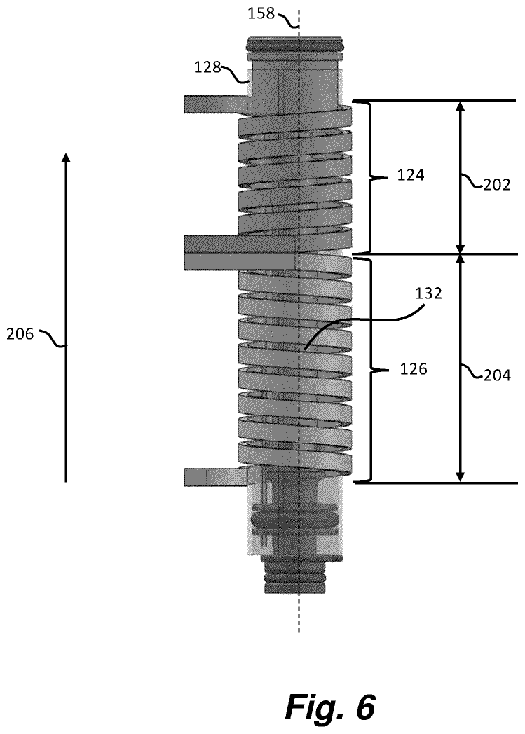

FIG. 6 depicts the heating assembly of the device 100. As briefly mentioned above, the heating assembly comprises a first inductor coil 124 and a second inductor coil 126 arranged adjacent to each other, in the direction along the axis 158 (which is also parallel to the longitudinal axis 134 of the device 100). In use, the first inductor coil 124 is operated initially. This causes a first section of the susceptor 132 to heat up (i.e. the section of the susceptor 132 surrounded by the first inductor coil 124), which in turn heats a first portion of the aerosol generating material. At a later time, the first inductor coil 124 may be switched off, and the second inductor coil 126 may be operated. This causes a second section of the susceptor 132 to heat up (i.e. the section of the susceptor 132 surrounded by the second inductor coil 126), which in turn heats a second portion of the aerosol generating material. The second inductor coil 126 may be switched on while the first inductor coil 124 is being operated, and the first inductor coil 124 may switch off while the second inductor coil 126 continues to operate. Alternatively, the first inductor coil 124 may be switched off before the second inductor coil 126 is switched on. A controller can control when each inductor coil is operated/energized.

In some examples, the length 202 of the first inductor coil 124 is shorter than the length 204 of the second inductor coil 126. The length of each inductor coil is measured in a direction parallel to an axis of the inductor coils 124, 126. The first, shorter inductor coil 124 may be arranged closer to the mouth end (proximal end) of the device 100 than the second inductor coil 126. When the aerosol generating material is heated, aerosol is released. When a user inhales, the aerosol is drawn towards the mouth end of the device 100, in the direction of arrow 206. The aerosol exits the device 100 via the opening/mouthpiece 104, and is inhaled by the user. The first inductor coil 124 is arranged closer to the opening 104 than the second inductor coil 126.

In this example, the first inductor coil 124 has a length 202 of about 20 mm, and the second inductor coil 126 has a length 204 of about 30 mm. A first wire, which is helically wound to form the first inductor coil 124, has an unwound length of about 285 mm. A second wire, which is helically wound to form the second inductor coil 126, has an unwound length of about 420 mm.

Each inductor coil 124, 126 is formed from litz wire comprising a plurality of wire strands. For example, there may be between about 25 and about 350 wire strands in each litz wire. In the present example, there are about 115 wire strands in each litz wire. In some examples, the wire strands are grouped into two or more bundles, where each bundle comprises a number of wire strands such that the wire strands in all bundles add up to the total number of wire strands. In the present example there are 5 bundles of 23 wire strands.

Each of the wire strands have a diameter. For example, the diameter may be between about 0.05 mm and about 0.2 mm. In some examples, the diameter is between 34 AWG (0.16 mm) and 40 AWG (0.0799 mm), where AWG is the American Wire Gauge. In this example, each of the wire strands have a diameter of 38 AWG (0.101 mm).

As shown in FIG. 6, the litz wire of the first inductor coil 124 is wrapped around the axis 158 about 5.75 times, and the litz wire of the second inductor coil 126 is wrapped around the axis 158 about 8.75 times. The litz wires do not form a whole number of turns because some ends of the litz wire are bent away from the surface of the insulating member 128 before a full turn is completed.

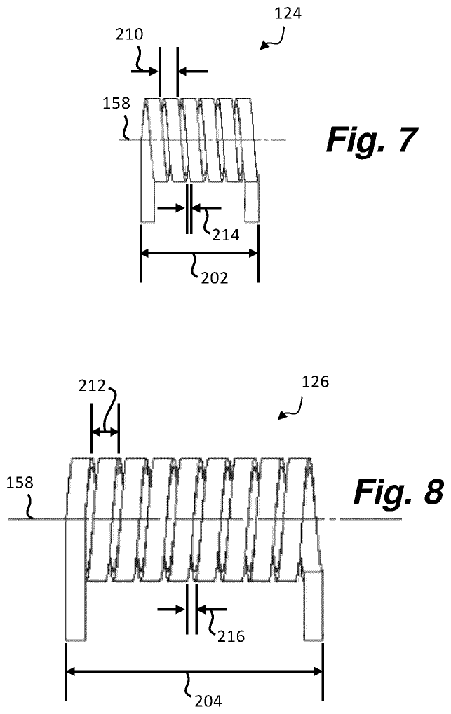

FIG. 7 shows a close up of the first inductor coil 124. FIG. 8 shows a close up of the second inductor coil 126. In this example, the first inductor coil 124 and the second inductor coil 126 have different pitches. The first inductor coil 124 has a first pitch 210, and the second inductor coil has a second pitch 212. The pitch is the length of the inductor coil (measured along the longitudinal axis 134 of the device or along the longitudinal axis 158 of the susceptor) over one complete winding. In this example, the first pitch is smaller than the second pitch, more specifically the first pitch 210 is about 3.1 mm, and the second pitch 212 is about 3.2 mm. In other example, the pitches are the same for each inductor coil, or the second pitch is smaller than the first pitch.

FIG. 7 depicts the first inductor coil 124 with about 5.75 turns, where one turn is one complete rotation around the axis 158. Between each successive turn, there is a gap 214. In this example, the length of the gap 214 is about 0.9 mm. Similarly, FIG. 8 depicts the second inductor coil 126 with about 8.75 turns. Between each successive turn, there is a gap 216. In this example, the length of the gap 216 is about 1 mm. The gap size is equal to the difference between the pitch and the dimension of the litz wire along the inductor coil/axis 158.

In this example, the first inductor coil 124 has a mass of about 2.4 g, and the second inductor coil 126 has a mass of about 3.5 g.

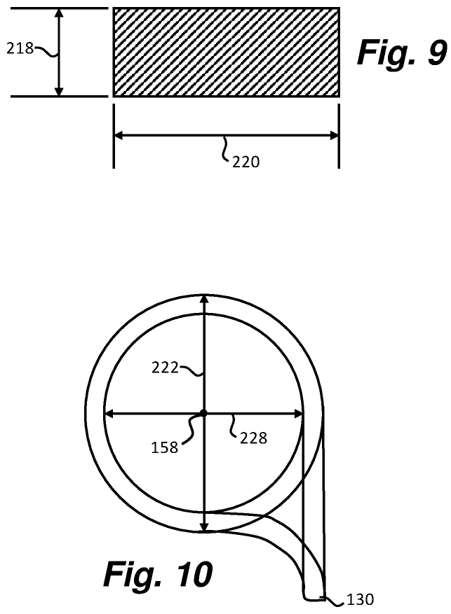

FIG. 9 is a diagrammatic representation of a cross section through the litz wire forming either of the first and second inductor coils 124, 126. As shown, the litz wire has a rectangular cross section (the individual wires forming the litz wire are not shown for clarity). The shorter side of the cross-section has a dimension 218 and the longer side of the cross-section has a dimension 220. In this example, the short side has a dimension 218 of about 1.1 mm, and the long side has a dimension 220 of about 2.2 mm. The total cross-sectional area is therefore about 2.42 mm². In the arrangement of FIGS. 5B and 6, the long side is arranged perpendicular to the longitudinal axis 158 of the susceptor 132 to achieve the desired magnetic field strength.

FIG. 10 is a diagrammatic representation of a top down view of either of the inductor coils 124, 126. In this example the inductor coil 124, 126 is arranged coaxially with the longitudinal axis 158 of the susceptor 132 (although the susceptor 132 is not depicted for clarity).

FIG. 10 shows the inductor coil 124, 126 with outer diameter 222 and an inner diameter 228. The outer diameter 222 may be between about 12 mm and about 16 mm and the inner diameter 228 may be between about 10 mm and about 14 mm. In this particular example, the inner diameter 228 is about 12 mm in length, and the outer diameter 222 is about 14.3 mm in length.

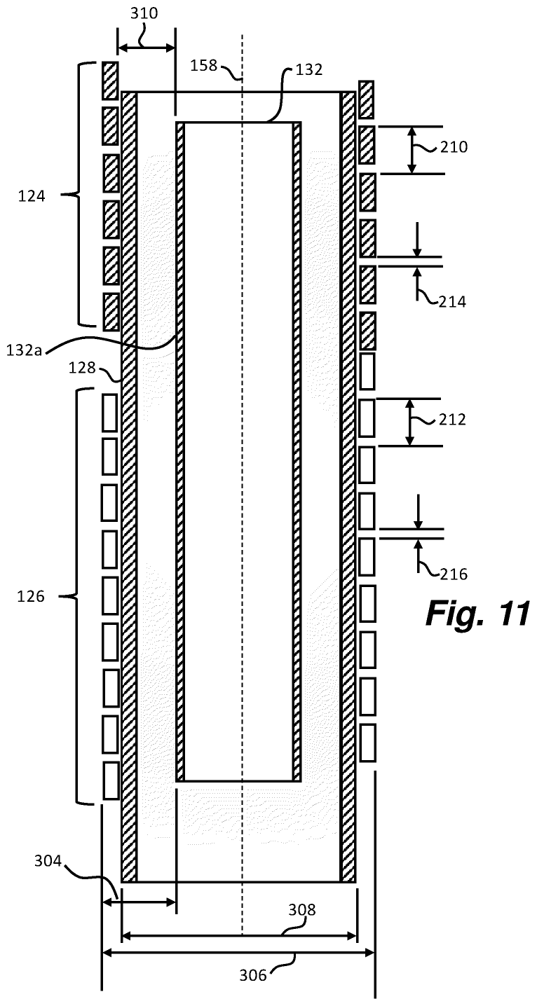

FIG. 11 is another diagrammatic representation of a cross section of the heating assembly. FIG. 11 depicts the outer perimeter/surface of the inductor coils 124, 126 being positioned away from the susceptor 232 by a distance 304. Accordingly, the first and second inductor coils have substantially the same external diameter 306. FIG. 11 also depicts the internal diameter 308 of the first and second inductor coils 124, 226 as being substantially the same.

The “outer perimeter” of the inductor coils 124, 226 is the edge of the inductor coil that is positioned furthest away from the outer surface 132a of the susceptor 132, in a direction perpendicular to the longitudinal axis 158.

As shown, the inner surfaces of the inductor coils 124, 126 are positioned away from the outer surface 132a of the susceptor 132 by a distance 310. The distance may be between about 3 mm and about 4 mm, such as about 3.25 mm.

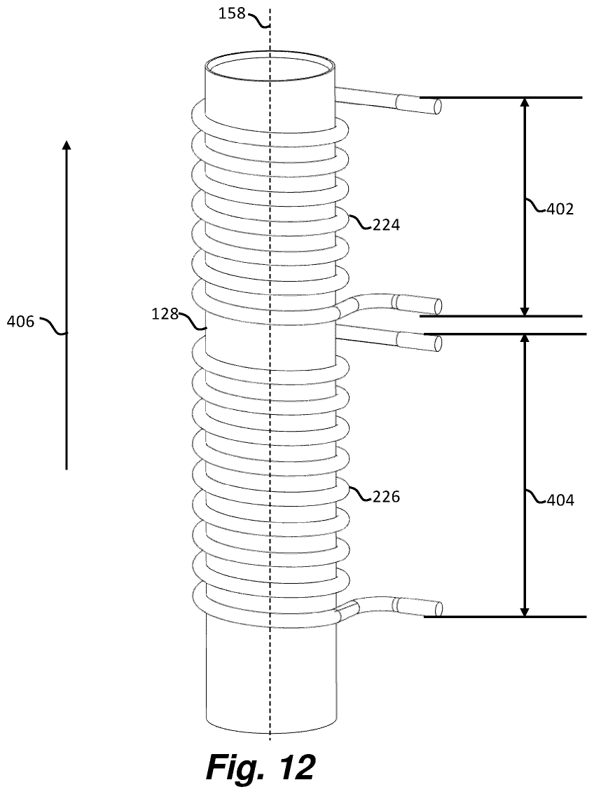

FIG. 12 depicts another heating assembly for use in the device 100. In this example, the rectangular cross section litz wires which form the inductor coils have been replaced with inductor coils comprising litz wire with a circular cross section. Other features of the device 100 are substantially the same.

The heating assembly comprises a first inductor coil 224 and a second inductor coil 226 arranged adjacent to each other, in the direction along a longitudinal axis 158 defined by the susceptor 132 (which is also parallel to the longitudinal axis 134 of the device 100). In use, the first inductor coil 224 is operated initially. This causes a first section of the susceptor 132 to heat up (i.e. the section of the susceptor 132 surrounded by the first inductor coil 224), which in turn heats a first portion of the aerosol generating material. At a later time, the first inductor coil 224 may be switched off, and the second inductor coil 226 may be operated. This causes a second section of the susceptor 132 to heat up (i.e. the section of the susceptor 132 surrounded by the second inductor coil 226), which in turn heats a second portion of the aerosol generating material. The second inductor coil 226 may be switched on while the first inductor coil 224 is being operated, and the first inductor coil 224 may switch off while the second inductor coil 226 continues to operate. Alternatively, the first inductor coil 224 may be switched off before the second inductor coil 226 is switched on. A controller can control when each inductor coil is operated/energized.

In some examples, the length 402 of the first inductor coil 224 is shorter than the length 404 of the second inductor coil 226. The length of each inductor coil is measured in a direction parallel to an axis defined by the inductor coils 224, 226. The first, shorter inductor coil 224 may be arranged closer to the mouth end (proximal end) of the device 100 than the second inductor coil 226. When the aerosol generating material is heated, aerosol is released. When a user inhales, the aerosol is drawn towards the mouth end of the device 100, in the direction of arrow 406. The aerosol exits the device 100 via the opening/mouthpiece 104 and is inhaled by the user. The first inductor coil 224 is arranged closer to the opening 104 than the second inductor coil 226.

In this example, the first inductor coil 224 has a length 402 of about 20 mm, and the second inductor coil 226 has a length 404 of about 27 mm. A first wire, which is helically wound to form the first inductor coil 224, has an unwound length of about 315 mm. A second wire, which is helically wound to form the second inductor coil 226, has an unwound length of about 400 mm.

Each inductor coil 224, 226 is formed from litz wire comprising a plurality of wire strands. For example, there may be between about 25 and about 350 wire strands in each litz wire. In the present example, there are about 115 wire strands in each litz wire. In some examples, the wire strands are grouped into two or more bundles, where each bundle comprises a number of wire strands such that the wire strands in all bundles add up to the total number of wire strands. In the present example there are 5 bundles of 23 wire strands.

Each of the wire strands have a diameter. For example, the diameter may be between about 0.05 mm and about 0.2 mm. In some examples, the diameter is between 34 AWG (0.16 mm) and 40 AWG (0.0799 mm), where AWG is the American Wire Gauge. In this example, each of the wire strands have a diameter of 38 AWG (0.101 mm).

As shown in FIG. 12, the litz wire of the first inductor coil 224 is wrapped around the axis 158 about 6.75 times, and the litz wire of the second inductor coil 226 is wrapped around the axis 158 about 8.75 times. The litz wires do not form a whole number of turns because some ends of the litz wire are bent away from the surface of the insulating member 128 before a full turn is completed.

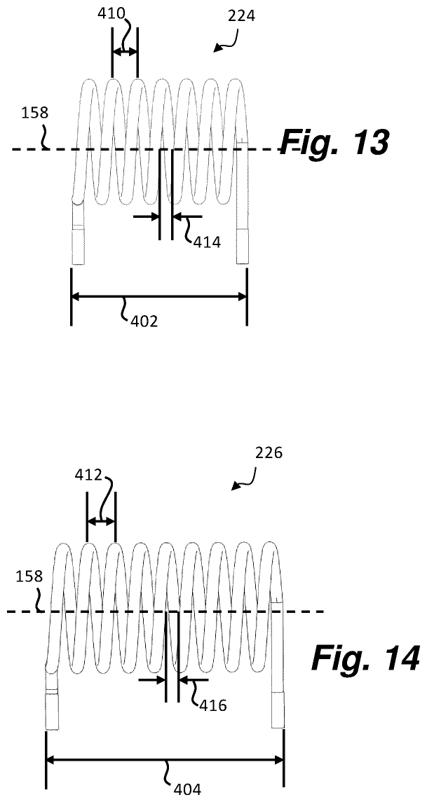

FIG. 13 shows a close up of the first inductor coil 224. FIG. 14 shows a close up of the second inductor coil 226. In this example, the first inductor coil 224 and the second inductor coil 226 have different pitches. The first inductor coil 224 has a first pitch 410, and the second inductor coil has a second pitch 412. The pitch is the length of the inductor coil (measured along the longitudinal axis 134 of the device or along the longitudinal axis 158 of the susceptor) over one complete winding. In this example, the first pitch is smaller than the second pitch, more specifically the first pitch 410 is about 2.81 mm, and the second pitch 412 is about 2.88 mm. In other example, the pitches are the same for each inductor coil, or the second pitch is smaller than the first pitch.

FIG. 13 depicts the first inductor coil 224 with about 6.75 turns, where one turn is one complete rotation around the axis 158. Between each successive turn, there is a gap 414. In this example, the length of the gap 414 is about 1.51 mm. Similarly, FIG. 14 depicts the second inductor coil 226 with about 8.75 turns. Between each successive turn, there is a gap 416. In this example, the length of the gap 416 is about 1.58 mm. The gap size is equal to the difference between the pitch and the diameter of the litz wire. Thus, in this example, the litz wire has a diameter of about 1.3 mm.

In this example, the first inductor coil 224 has a mass of about 1.4 g, and the second inductor coil 226 has a mass of about 2.1 g.

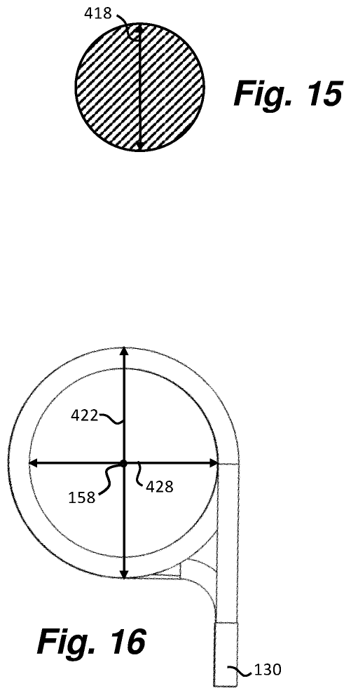

FIG. 15 is a diagrammatic representation of a cross section through the litz wire forming either of the first and second inductor coils 224, 226. As shown, the litz wire has a circular cross section (the individual wires forming the litz wire are not shown for clarity). The litz wire has a diameter 418, which may be between about 1 mm and about 1.5 mm. In this example, the diameter is about 1.3 mm.

FIG. 16 is a diagrammatic representation of a top down view of either of the inductor coils 224, 226. In this example the inductor coil 224, 226 is arranged coaxially with the longitudinal axis 158 of the susceptor 132 (although the susceptor 132 is not depicted for clarity).

FIG. 16 shows the inductor coil 224, 226 with outer diameter 422 and an inner diameter 428. The outer diameter 422 may be between about 12 mm and about 16 mm and the inner diameter 428 may be between about 10 mm and about 14 mm. In this particular example, the inner diameter 428 is about 12 mm in length, and the outer diameter 422 is about 14.6 mm in length.

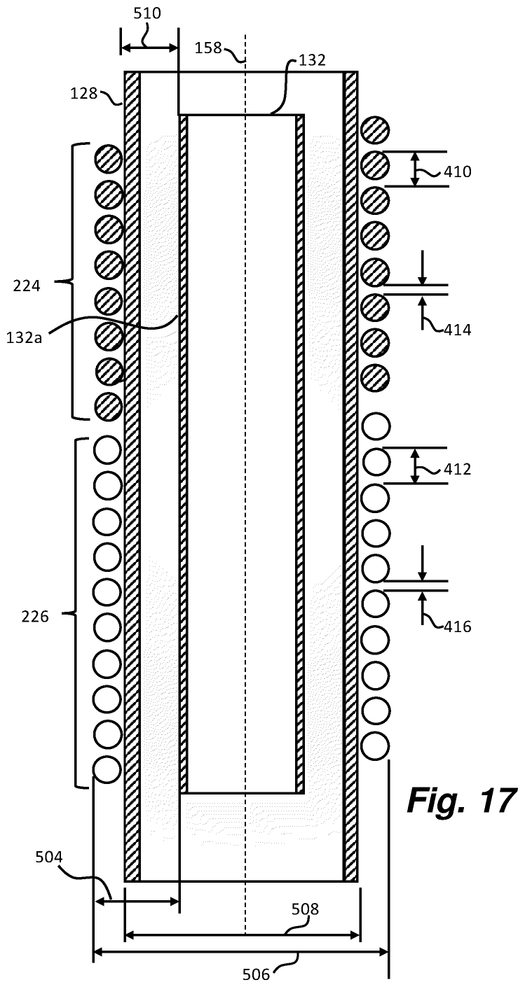

FIG. 17 is another diagrammatic representation of a cross section of the heating assembly. FIG. 17 depicts the outer perimeter/surface of the inductor coils 224, 226 being positioned away from the susceptor 232 by a distance 504. Accordingly, the first and second inductor coils have substantially the same external diameter 506. FIG. 17 also depicts the internal diameter 508 of the first and second inductor coils 224, 226 as being substantially the same.

The “outer perimeter” of the inductor coils 224, 226 is the edge of the inductor coil that is positioned furthest away from the outer surface 132a of the susceptor 132, in a direction perpendicular to the longitudinal axis 158.

As shown, the inner surfaces of the inductor coils 224, 226 are positioned away from the outer surface 132a of the susceptor 132 by a distance 510. The distance may be between about 3 mm and about 4 mm, such as about 3.25 mm.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device, comprising:
an inductor coil configured to generate a varying magnetic field for heating a susceptor arrangement, wherein the inductor coil is helical and formed from litz wire having an elliptical cross section and comprising between about 25 and about 350 wire strands.

2. An aerosol provision device according to claim 1, wherein the litz wire comprises between about 60 and about 150 wire strands.

3. An aerosol provision device according to claim 2, wherein the litz wire comprises between about 100 and about 130 wire strands.

4. An aerosol provision device according to claim 3, wherein the litz wire comprises about 115 wire strands.

5. An aerosol provision device according to claim 1, wherein the litz wire comprises at least four bundles of wire strands.

6. An aerosol provision device according to claim 5, wherein there is the same number of wire strands in each of the least four bundles.

7. An aerosol provision device according to claim 1, wherein the wire strands have a diameter of between about 0.05 mm and about 0.2 mm.

8. An aerosol provision device according to claim 7, wherein the wire strands have a diameter of about 0.1 mm.

9. An aerosol provision device according to claim 1, wherein the litz wire has a length of between about 300 mm and about 450 mm.

10. An aerosol provision device according to claim 1, wherein the inductor coil has between about 6 and 9 turns.

11. An aerosol provision device according to claim 1, wherein the inductor coil comprises gaps between successive turns and each gap has a length of between about 1.4 mm and about 1.6 mm.

12. An aerosol provision device according to claim 1, wherein the inductor coil has a mass of between about 1 g and about 2.5 g.

13. An aerosol provision device according to claim 1, wherein the litz wire has a circular cross section.

14. An aerosol provision device according to claim 14, wherein the litz wire has a diameter of between about 1 mm and about 1.5 mm.

15. An aerosol provision device according to claim 14, wherein the litz wire has a diameter of between about 1.2 mm and about 1.4 mm.

16. An aerosol provision device according to claim 1, further comprising:
the susceptor arrangement, wherein the susceptor arrangement is heatable by penetration with the varying magnetic field to heat aerosol generating material.

17. An aerosol provision system, comprising:
an aerosol provision device according to claim 1; and
an article comprising aerosol generating material.

18. An aerosol provision device, comprising:
an inductor coil configured to generate a varying magnetic field for heating a susceptor arrangement, wherein the inductor coil is helical and formed from litz wire having a rectangular cross section and comprising between about 25 and about 350 wire strands.

19. An aerosol provision device according to claim 18, wherein the litz wire comprises between about 60 and about 150 wire strands.

20. An aerosol provision device according to claim 19, wherein the litz wire comprises between about 100 and about 130 wire strands.

21. An aerosol provision device according to claim 20, wherein the litz wire comprises about 115 wire strands.

22. An aerosol provision device according to claim 18, wherein the litz wire comprises at least four bundles of wire strands.

23. An aerosol provision device according to claim 22, wherein there is the same number of wire strands in each of the least four bundles.

24. An aerosol provision device according to claim 18, wherein the wire strands have a diameter of between about 0.05 mm and about 0.2 mm.

25. An aerosol provision device according to claim 24, wherein the wire strands have a diameter of about 0.1 mm.

26. An aerosol provision device according to claim 18, wherein the litz wire has a length of between about 250 mm and about 450 mm.

27. An aerosol provision device according to claim 18, wherein the inductor coil has between about 5 and 9 turns.

28. An aerosol provision device according to claim 18, wherein the inductor coil comprises gaps between successive turns and each gap has a length of between about 0.9 mm and about 1 mm.

29. An aerosol provision device according to claim 18, wherein the inductor coil has a mass of between about 2 g and about 4 g.

30. An aerosol provision device according to claim 18, wherein the litz wire has a cross sectional area of between about 1.5 mm² and about 3 mm².

31. An aerosol provision device according to claim 18, further comprising:
the susceptor arrangement, wherein the susceptor arrangement is heatable by penetration with the varying magnetic field to heat aerosol generating material.

32. An aerosol provision system, comprising:
an aerosol provision device according to claim 18; and
an article comprising aerosol generating material.
